(19) United States
(12) Patent Application Publication
(10) Pub. No.: US 2004/0130304 A1
(43) Pub. Date: Jul. 8, 2004

(54) VOLTAGE REGULATOR HAVING A VOLTAGE DOUBLER DEVICE

(75) Inventor: Thomas W. Lanni, Laguna Niguel, CA (US)

Correspondence Address: Mark R. Kendrick, PILLSBURY WINTHROP LLP, Suite 2800, 725 South Figueroa Street, Los Angeles, CA, 90017, US

(73) Assignee: COMARCO WIRELESS TECHNOLOGIES, INC., Irvine, CA (US)

(21) Appl. No.: 10/336,585

(22) Filed: Jan. 3, 2003

(51) Int. Cl. G05F 1/40

(52) U.S. Cl. 323/282

(57) ABSTRACT

A voltage regulator receives an external input voltage, either a rectified alternating current (AC) voltage or a direct current (DC) voltage and converts it to an input voltage. The voltage regulator outputs a correction signal from the output correcting device to direct a voltage boosting device to a regulated output-to-input voltage ratio. The voltage boosting device receives the input voltage and receives the direction of the correction signal and outputs a regulated DC output voltage that maintains a regulated output-to-input voltage ratio. In a second aspect of the invention, the voltage regulator receives a voltage control input at an output correcting device. The voltage regulator outputs a correction signal from the output correcting device to direct a voltage boosting device to an established ratio of an actual-to-control voltage ratio.

### BACKGROUND

I. Technical Field

This invention relates to power conversion. More specifically, this invention relates to the regulation of a direct current (DC) output voltage utilizing a small number of magnetic elements.

2. Discussion of the Related Art

In existing voltage regulators, the power conversion portion of the regulator utilizes multiple magnetic elements to convert either an AC input voltage or a DC input voltage to a regulated DC output voltage. For example, the power converter utilizes a transformer and a rectifier to convert the AC voltage to a DC voltage. The DC voltage output from the rectifier is regulated by a Buck regulator and transferred from the Buck regulator through an inductor to an output load. The transformer, rectifier, and inductor consume power from the system, thereby increasing power system losses. In these power conversion devices, the number of magnetic elements lead to losses of power efficiency. Therefore, it would be desirable to have a power conversion device that could increase or decrease output power and be able to increase or decrease the output voltage, e.g., double the input voltage, in an efficient manner without losing power due to the inclusion of multiple magnetic elements.

### BRIEF DESCRIPTION OF THE DRAWINGS

FIG. 1 illustrates a voltage regulator according to an embodiment of the present invention;

FIG. 2(a) is a graph illustrating an oscillating signal and a first correction signal under two operating conditions, according to an embodiment of the present invention;

FIG. 2(b) is a graph illustrating a first switching signal under an operating condition according to an embodiment of the present invention;

FIG. 2(c) is a graph illustrating a first switching signal under a different operating condition according to an embodiment of the present invention;

FIG. 3 illustrates a voltage boosting device according to an embodiment of the present invention;

FIG. 4(a) is a graph illustrating a duty cycle of 0.5 for a first driving signal and a duty cycle of 0.5 for a second driving signal according to an embodiment of the present invention;

FIG. 4(b) is a graph illustrating a duty cycle of 0.375 for a first driving signal and a duty cycle of 0.625 for a second driving signal according to an embodiment of the present invention;

FIG. 5 is a graph illustrating the increase in voltage produced by the voltage boosting device according to an embodiment of the present invention;

FIG. 6 is a schematic illustrating a specific embodiment of the output correcting device according to an embodiment of the present invention; and

FIG. 7 is a schematic illustrating a specific embodiment of the voltage regulator, except for the output correcting device, according to an embodiment of the present invention.

### DETAILED DESCRIPTION

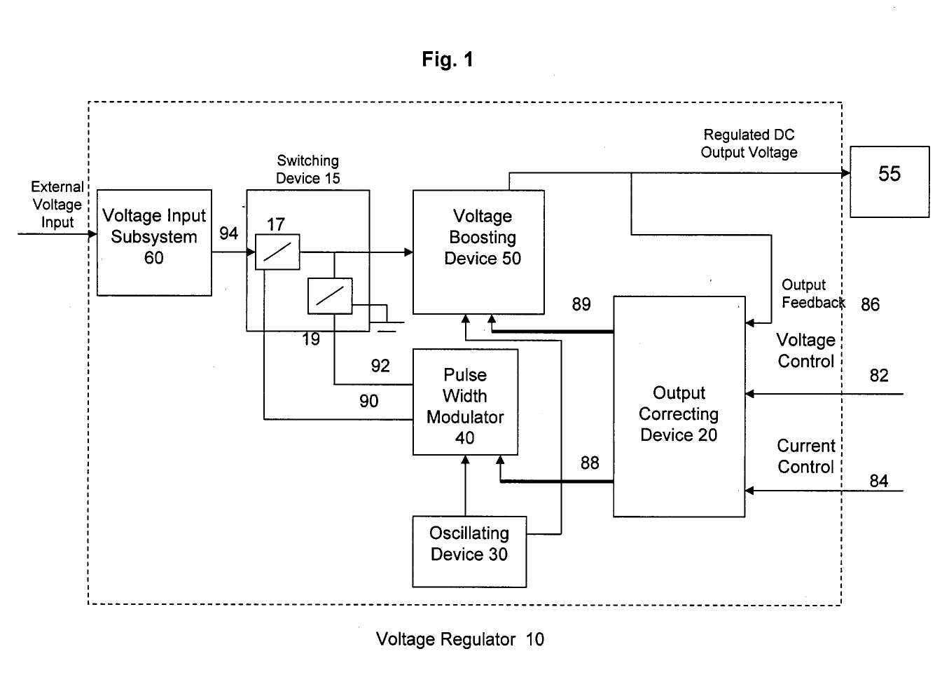

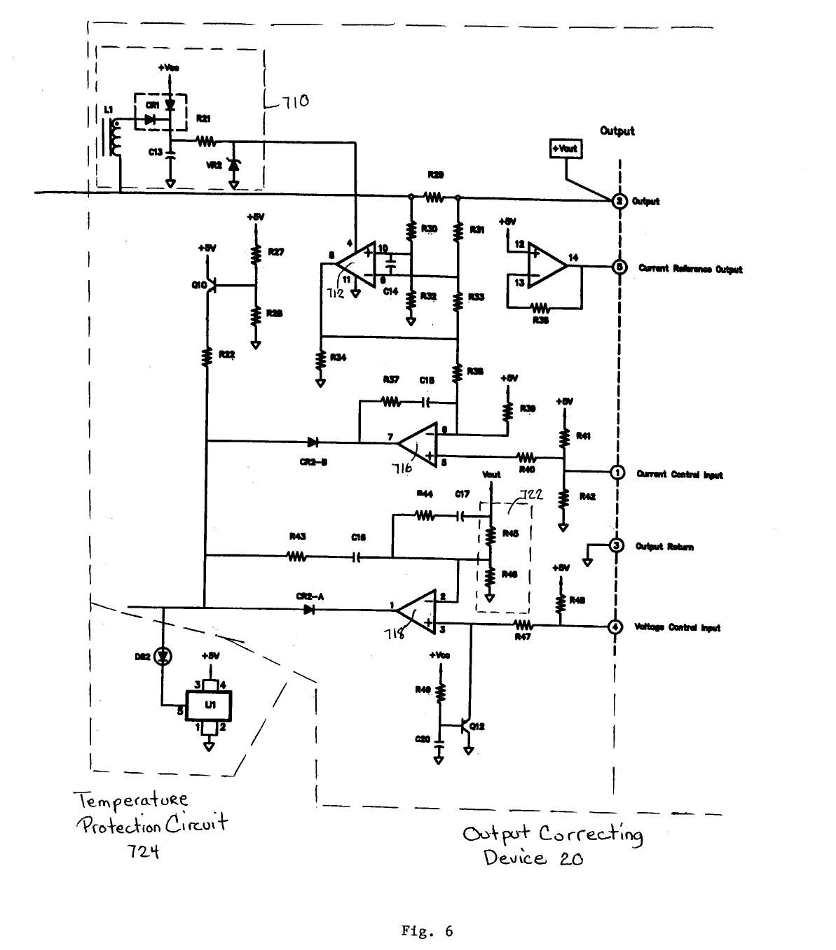

FIG. 1 illustrates a voltage regulator according to an embodiment of the present invention. The voltage regulator 10 may include a voltage input subsystem 60, a switching device 15, a pulse width modulator 40, a voltage boosting device 50, an output correcting device 20 and an oscillating device 30. The voltage converting device 10 may also include a temperature protection circuit (shown as 724 in FIG. 6). The voltage regulator 10 may receive an external voltage input to the voltage input subsystem 60. The external voltage input may be a rectified alternating current (AC) external voltage or a direct current (DC) external voltage. The voltage input subsystem 60 may provide a voltage input, i.e., a DC voltage input. The voltage regulator may provide a regulated DC output voltage to power an external device. The external device may be referred to as the external load device 55. The voltage regulator 10 may provide the regulated DC output voltage by monitoring a voltage control input 82 and the actual output voltage supplying the external load device 55. Alternatively, the voltage regulator 10 may provide the regulated DC output voltage by monitoring only the actual output voltage. In an embodiment of the invention, the voltage regulator 10 may also monitor a current control input 84.

The desired regulated DC output voltage may be higher than the input voltage of the voltage input subsystem 60 or the desired regulated DC output voltage may be lower than the input voltage of the voltage input subsystem 60. A regulated output-to-input voltage ratio may be provided for the voltage regulator 10. For example, the input voltage may be 12 Volts, and the desired regulated DC output voltage may be 24 volts; in such case, the voltage regulator 10 has a regulated output-to-input voltage ratio of 2. As another example, the desired regulated DC output voltage may be 9 volts, and the regulated output-to-input voltage ratio may be 0.75.

The voltage control input 82 may initially be determined by an external voltage control device, such as a power tip adapter. The voltage regulator 10 may establish the regulated DC output voltage with respect to the voltage control input 82. This may be referred to as an established actual-to-control voltage ratio. In an embodiment of the invention, the components that comprise the circuitry of the output correcting device 20, the pulse width modulator 40, the switching device 15, and the voltage boosting device 50 may drive the actual-to-control voltage ratio to 3, i.e., the regulated DC output voltage is three times the voltage control input. Therefore, the voltage regulator 10 may provide a regulated DC output voltage that maintains the regulated output-to-input voltage and provides the established actual-to-control voltage ratio.

Once the voltage regulator 10 reaches a steady-state, operating conditions may change, and the external load device's 10 current needs may change, i.e., more current may be requested. For example, a DVD drive may spin-up on a personal computer so that the personal computer, i.e., the external load device 55, may demand more current from the voltage regulator 10. The regulated DC output voltage may dip in response to the demand for more current. Because the voltage regulator 10 is monitoring the regulated DC output voltage, the voltage regulator 10 responds to the dip in the regulated DC output voltage and drives the regulated DC output voltage back to the desired level. The voltage regulator 10 may manipulate the switching device 15 and the voltage boosting device 50 to provide the necessary regulated DC output voltage which maintains the established actual-to-control voltage ratio of the voltage regulator 10 and the regulated output-to-input voltage ratio of the voltage regulator 10.

Once the voltage regulator 10 reaches a steady-state, the voltage regulator 10 may also check to make sure that too much current is not being supplied to the external device. For example, if a short circuit occurs in the external load device 55, the external load device 55 may request excessive current. In response to this condition, the voltage regulator 10 may eliminate the regulated DC output voltage, i.e., keep the voltage regulator 10 from providing a regulated DC output voltage.

The voltage regulator 10 is efficient in that only one magnetic element is utilized, i.e., an inductor is utilized in the voltage boosting device 50. This leads to a smaller size package for the voltage regulator 10. The efficiency of the circuit is also increased because of the use of the single inductor in the voltage boosting device 50. The efficiency is increased because the voltage regulator utilizes low-loss switches in place of a rectifier that includes diodes. The voltage regulator 10 produces power densities of approximately 40 watts per cubic inch in a convection cooled package.

A temperature protection circuit 724 may be included in the voltage regulator 10. The temperature protection circuit 70 may disable the voltage regulator 10 if a temperature threshold is crossed.

Referring again to FIG. 1, the voltage regulator 10 may initially receive a voltage control input 82 into an output correcting device 20. The voltage regulator 10 may be configured to provide a specific, or established, actual-to-control voltage ratio. In an embodiment of the invention, the established actual-to-control voltage ratio may be 3.

The voltage regulator 10 may also receive an output feedback signal 86, which is derived from the regulated DC output voltage. The output feedback signal 86 may be the actual voltage being supplied to the external load device 55, or a derivative thereof. The output correcting device 20 may determine if the actual-to-control voltage ratio is being met and may output a correction signal(s) 88 and 89 to attempt to modify the regulated DC output voltage if the actual-to-control voltage ratio is not at the voltage regulator's desired actual-to-control voltage ratio. As illustrated in FIG. 1, the correction signal(s) 88 and 89 may output a similar signal to the pulse width modulator 40 and the voltage boosting device 50. In operating conditions where the actual-to-control voltage ratio is too high, i.e., the regulated DC output voltage is at too high a level as compared to the voltage control input 82, the output correcting device 20 may output the correction signal(s) 88 and 89 to decrease the regulated DC output voltage. In operating conditions where the actual-to-control voltage ratio is too low, i.e., the regulated DC output voltage is at too low a level as compared to the voltage control input, the output correcting device 20 may output the correction signal(s) 88 and 89 to increase the regulated DC output voltage.

Under alternative operating conditions, the voltage regulator 10 may receive the output feedback signal 86, which is derived from the regulated DC output voltage. The output correcting device 20 may determine if the regulated output-to-input voltage ratio is being maintained. The output correcting device 20 may output the correction signal(s) 88 and 89 to assist in modifying the regulated DC output voltage.

Correction signal 88 may be input to the pulse width modulator 40 and correction signal 89 may be input to the voltage boosting device 50. In an operating condition where the regulated output-to-input voltage ratio is greater than 1, the pulse width modulator 40 may receive the correction signal 88 and an oscillating signal from the oscillating device 30 may also be supplied to the pulse width modulator 40. The pulse width modulator 40 may generate a first switching signal 90 to close or turn on, a first switch 17 of the switching device 15 continuously. During this operating condition, the magnitude of the input voltage 94 may be the same at the output of the voltage input subsystem 60 as it is at the input of the voltage boosting device 50, meaning the switching device does not change the magnitude of the input voltage 94.

The voltage boosting device 50 may receive the correction signal 89 from the output correction device 20 and the oscillating signal from the oscillating device 30. In an operating condition where the regulated output-to-input voltage ratio is greater than 1, the voltage boosting device 50 may increase, or boost, the input voltage 94 to create and output the regulated DC output voltage to the external load device 55. The magnitude of how much the voltage boosting device 50 increases the regulated DC output voltage may be dependent on the whether the correction signal 89 was requesting an increase in output voltage or whether it was requesting a decrease in output voltage.

In an operating condition where the regulated output-to-input voltage ratio is less than or equal to one, the pulse width modulator 40 may receive the correction signal 88 and the oscillating signal, and the pulse width modulator 40 may generate a first switching signal 90 to close and open the pass switch 17 of the switching device 15 and a second switching signal 92 to close and open the shunt switch 19 of the switching device 15. The opening and closing of the pass switch 17 and the shunt switch 19 of the switching device 15 may decrease the magnitude of the input voltage 94 into the voltage boosting device 50 because the path between the voltage input subsystem 60 and the voltage boosting device 50 is only open for a period of time. The magnitude of input voltage 94 into the voltage boosting device 50 may be dependent upon whether the correction signal 88 was requesting a higher or lower regulated DC output voltage.

In this operating condition, i.e., the regulated output-to-input voltage ratio is less than or equal to one, the voltage boosting device 50 may receive the correction signal 89 and the oscillating signal, and may either leave unchanged or slightly increase the input voltage 94 to the voltage boosting device 50 to create the regulated DC voltage output. Whether the voltage boosting device 50 maintains or slightly increases the input voltage 94 to the voltage boosting device 50 in creating the regulated DC voltage output may be dependent on whether the correction signal requested a higher or lower regulated DC voltage output. The external load device 55 may utilize the regulated DC output voltage as a supply voltage.

Referring to FIG. 1, in an embodiment of the invention, an external voltage setting device (not shown) may provide a voltage control signal 82 to the output correcting device 20 to assist the voltage regulator 10 in providing the regulated DC output voltage utilized by the external load device 55. In an embodiment of the invention, the external voltage setting device may be a passive component, e.g., a resistor, disposed in a connector which mechanically mates with a power input jack of the external load device 55. In another embodiment of the invention, the voltage control signal may be produced by an external voltage setting device with active circuitry disposed in a connector.

In embodiments of the invention, an external current limiting device may provide a current control signal 84 to the output correcting device 20 to ensure that excess current is not provided to the external load device 55. For example, if the external load device 55 appears as a short circuit to the voltage regulator 10, the voltage regulator 10 may shut off so as to not deliver any voltage to the external load device 55.

A first output feedback signal and a second output feedback signal may be determined from the regulated DC output voltage by the output correcting device 20. The first output feedback signal may be a reference output voltage. The second output feedback signal may be a reference output current.

In an embodiment of the invention, the voltage control signal 82 may be compared to the reference output voltage 86 in the output correcting device 20 and the correction signal(s) 88 and 89 may be generated. For example, if a current actual-to-control voltage ratio is not equal to the voltage regulator's 10 desired actual-to-control voltage ratio, the output correcting device 20 may output a correction signal which causes a change in the regulated DC output voltage so that the desired actual-to-control voltage ratio is obtained.

The current control signal may be compared to reference output current in the output correcting device 20 and a correction signal may be generated if the reference output current has exceeded a current limit set by the current control signal. The output correcting device 20 may output the correction signal identifying that the voltage regulator 10 should cease to produce the regulated DC output until the reference output current is lower than the current limit set by the current control signal 84.

In an alternative embodiment of the present invention, the output correcting device 20 may only monitor the reference output voltage 86. The output correcting device 20 may generate the correction signal(s) 88 and 89 identifying that the DC regulated output voltage may need to be adjusted.

As illustrated in FIG. 1, the correction signal(s) 88 and 89 may be transmitted to the voltage boosting device 50 and the pulse width modulator 40, respectively. In the pulse width modulator 40, the correction signal 88 may need to derive a first correction signal and a second correction signal. In an embodiment of the invention, the first correction signal (not shown) and the second correction signal (not shown) may each be a direct current (DC) voltage. In an embodiment of the invention, the first correction signal and the second correction signal may have slightly different values.

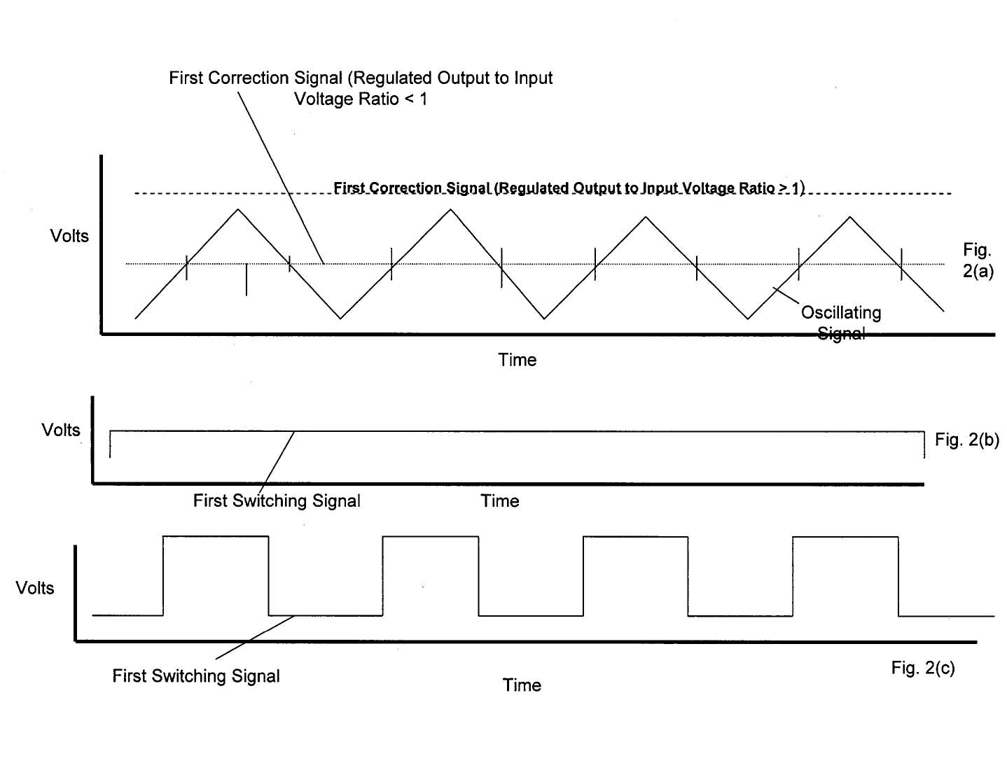

An oscillating signal from the oscillating device 30 may also be transmitted to the pulse width modulator 40 and the voltage boosting device 50. In the pulse width modulator 40, the oscillating signal may be compared to the first correction signal to generate the first switching signal 90. In embodiments of the invention the oscillating signal may be a triangular wave as illustrated in FIG. 2(a). The first switching signal 90 output by the pulse width modulator 40 may control the opening and closing of the pass switch 17 in the switching device 15. For example, where operating conditions of the voltage regulator 10 dictate that the regulated DC output voltage utilized by the output load is higher than the input voltage, i.e., the regulated output-to-input voltage ratio is greater than 1, the first switching signal 90 may be driven to a high state continuously, as illustrated in FIG. 2(b), which causes the pass switch 17 in the switching device 15 to be closed continuously. This waveform is created by the pulse width modulator 40 because the first correction signal may be a DC signal that has a value higher than the highest point on the oscillating signal, as illustrated by the dashed line in FIG. 2(a).

Conversely, where operating conditions of the voltage regulator 10 dictate that the regulated DC output voltage utilized by the output load is lower than the input voltage, i.e., the regulated output-to-input voltage ratio is less than or equal to 1, the first switching signal 90 may take the form of a squarewave, as illustrated in FIG. 2(c). This waveform may be created because the first correction signal may be a DC signal that has a value that intersects with the oscillating signal waveform, as illustrated by the dotted line in FIG. 2(a). In embodiments of the invention where the first switching signal is a squarewave, the pass switch 17 in the switching device 15 may be closed when the first switching signal 90 is high and open when the first switching signal 90 is low.

The switching device 15 may also include a shunt switch 19. The second switch may be driven by a second switching signal 92, which is almost the reciprocal signal of the first switching signal 90, e.g., if the first switching signal 90 is in a high state, the second switching signal 92 is in a low state. Delays may be introduced into the second switching signal 92 to prevent the pass switch 17 and the shunt switch 19 from being closed, or turned on, at the same time. The second switching signal 92 may be generated by comparing the second correction signal to the oscillating signal. The second switching signal 92 may be transferred to the shunt switch 19 in the switching device 15. In this embodiment of the invention, the shunt switch 19 provides a return path for current from the voltage boosting device 50 when the pass switch 17 is turned off, i.e., open.

Where the operating conditions of the voltage regulator 10 dictate that the first switching signal 90 and the second switching signal 92 are square wave(s), i.e., the regulated output-to-input voltage ratio is less than or equal to 1, the average input voltage, transmitted to the voltage boosting device 50, may be decreased because the pass switch 17 and the shunt switch 19 are only transferring the input voltage 94 to the voltage boosting device 50 a certain percentage of the time. In this embodiment, the average input voltage may be proportioned to the amount of time the first switching signal 90, is in a high state. For example, if the first switching signal 90 is in a high state 60% of the time, the average input voltage may be 0.60× the magnitude of the DC input voltage.

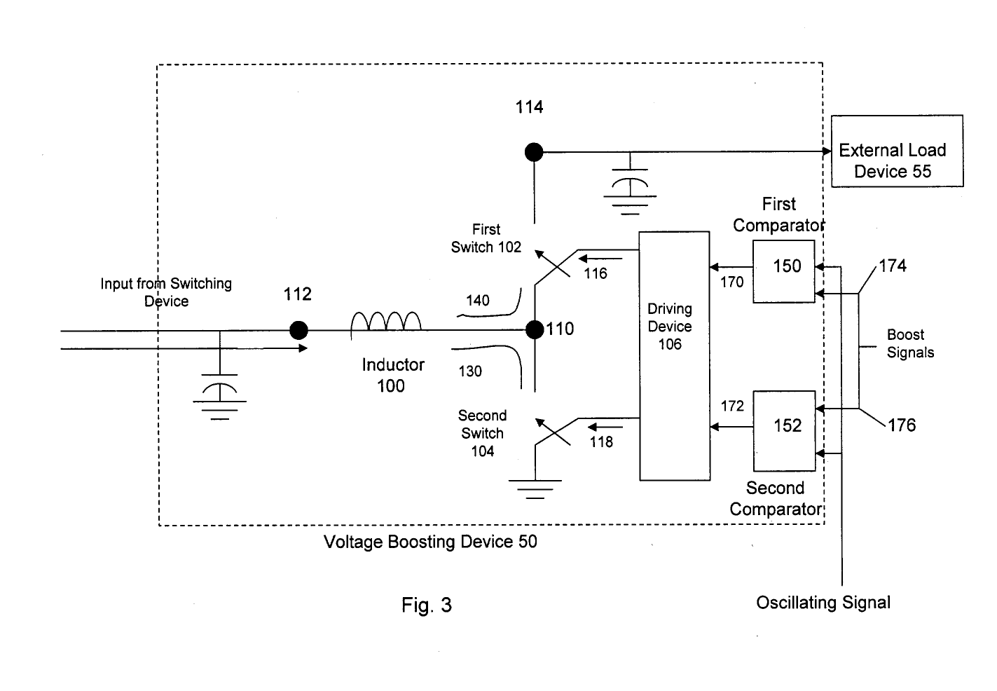

FIG. 3 illustrates a voltage boosting device according to an embodiment of the present invention. The voltage boosting device 50 may include only a single magnetic element, i.e., an inductor 100, which may minimize the loss of power that normally occurs in voltage conversion operations.

The voltage boosting device 50 may include the inductor 100, a first switch 102, a second switch 104, a driving device 106, a first comparator 150, and a second comparator 152. In one embodiment of the invention, the driving device 106 may be a half-bridge driver self-oscillator. In an alternative embodiment of the invention, the transistor driving device 106 may be a half-bridge driver that does not have an internal oscillator. In this embodiment of the invention, the oscillator may be implemented by utilizing discrete components not internal to the half-bridge driver.

As illustrated in FIG. 3, node 114 may be coupled to the external load device 55 and to a first terminal of a first switch 102. A node 110 may be coupled to a second terminal of the first switch 102, a first terminal of the second switch 104, and an output terminal of the inductor 100. Node 112 may be coupled to an input terminal of the inductor 100 and an output terminal of a switching device 15. In this embodiment, the second terminal of the second switch 104 may be coupled to a reference, e.g., ground potential.

In an operating condition of the invention where the regulated DC output voltage utilized by the external load device 55 is greater than the input voltage supplied by the voltage generating subsystem, i.e., the regulated output-to-input ratio is greater than one, the input voltage transferred through the switching device 15 may be provided to node 112 and to the input terminal of the inductor 100. The driving device 106 may control the opening and closing of the first switch 102 and the second switch 104 by providing a first driving signal 116 to a control terminal of the first switch 102 and by providing a second driving signal 118 to a control terminal of the second switch 104.

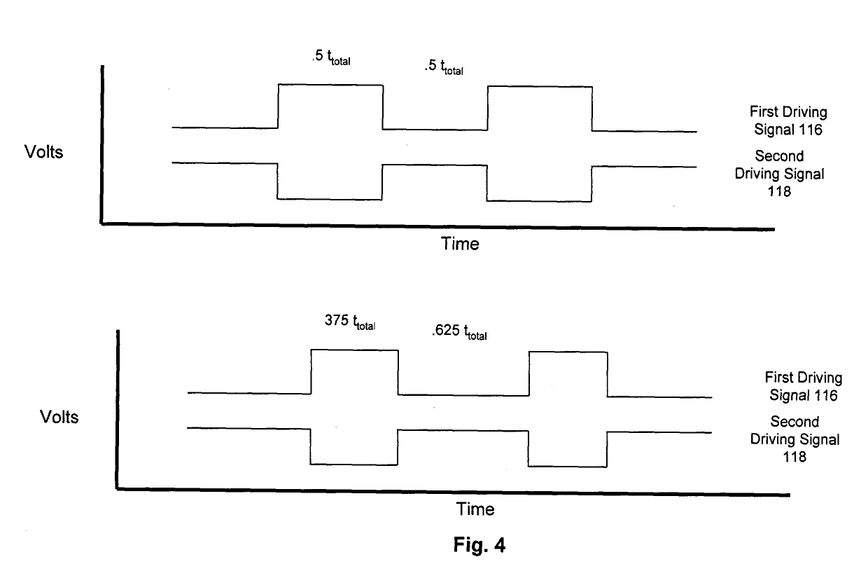

The first driving signal 116 and the second driving signal 118 may be pulsed signals operating at a specific frequency, e.g., 100 Kilohertz. The first driving signal 116 and the second driving signal 118 may operate at various frequencies and 100 Kilohertz is merely a representative value. The first driving signal 116 and the second driving signal 118 may be square wave signals operating at the same frequency. The duty cycle of the first driving signal 116 and the duty cycle of the second driving signal 118 may add to a value of one. This may allow one of the first driving signal 116 and the second driving signal 118 to be driving the first switch 102 or the second switch 104, respectively, at a point in time. For example, the duty cycle of the first transistor driving signal 116 may be 0.5 and the duty cycle of the second transistor driving signal 118 may be 0.5, as illustrated in FIG. 4(a). Alternatively, the duty cycle of the first transistor driving signal 116 may be 0.375 and the duty cycle of the second transistor driving signal 118 may be 0.625, as illustrated in FIG. 4(b).

The duty cycle of the first driving signal 116 and the duty cycle of the second driving signal 118 may be determined by a high driving device signal 170 and a low driving device signal 172, respectively, as illustrated in FIG. 3. A first comparator 150 may output the high driving device signal 170 and a second comparator 152 may output the low driving device signal 172.

As illustrated by FIG. 1, the correction signal may be transmitted to the voltage boosting device 50. The voltage boosting device 50 may receive the correction signal and may create a first boost correction signal 174 and a second boost correction signal 176. The first boost correction signal 174 and the second boost correction signal 176 may have different values. In an embodiment of the invention, the first boost correction signal 174 is compared to the oscillating signal from the oscillating device 30 to create the high driving device signal 170. In this embodiment, the second boost correction signal 176 is compared to the oscillating signal to create the low driving device signal 172. The second boost correction signal 176 may be close to the reciprocal of the first boost correction signal 174, with a little delay built in to make sure the first switch 102 and the second switch 104 are not turned on at the same moment in time. The high driving device signal 170 may correspond in shape and timing to the first driving signal 116 and the low driving device signal 172 may correspond in shape and timing to the second driving signal 118.

Where operating conditions of the voltage regulator 10 dictate that the regulated output-to-input voltage ratio is greater than one, the high state of second driving signal 118 may cause the closing of the second switch 104. This creates a path from node 112 to node 110, and further to a reference point, e.g., ground, through the closed second switch 104. This is illustrated by path 130. In this embodiment when the high state of the second driving signal 118 is causing the closing of the second switch 104, a stored current may be built up and energy may be stored in the inductor 100.

The second driving signal 118 may change to a low state, which opens the second switch 104. At close to the same time, the first driving signal 116 may change to a high state, which closes the first switch 102. If the second switch 104 is open, and the first switch 102 is closed, then a path is formed from the output terminal of the inductor 100 through node 110, and further through the first switch 102 to node 114. This is illustrated by path 140.

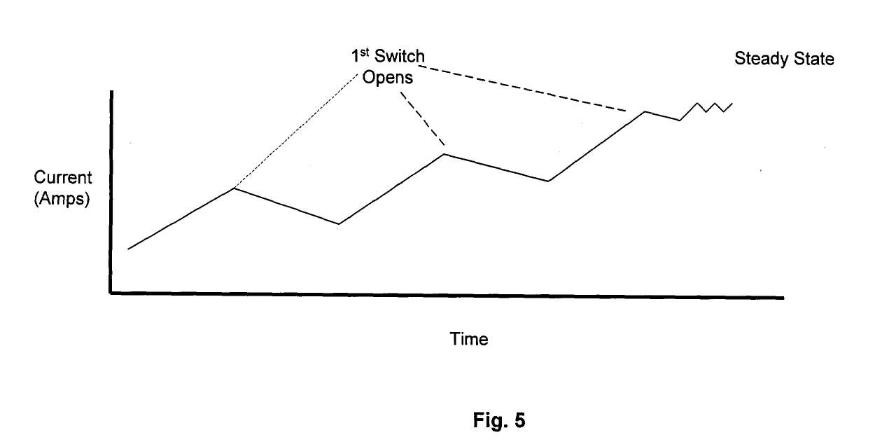

When the first switch 102 is closed, the stored current that built up in the inductor 100 may be discharged along the path 140 to the external load device 55. The stored current discharging from the inductor 100 does not occur instantaneously. In other words, the stored current discharging from the inductor 100 may discharge over a period of time, as illustrated by the ramped nature of the signal in FIG. 5. In addition, because the first switch 102 may be opened and closed at a rapid rate, the stored current in the inductor 100 may not be completely discharged before the first switch 102 is opened again. The non-complete discharge of the inductor current in successive time intervals is illustrated in FIG. 5 by the continuing increase of the total output current until an equilibrium state is reached.

The voltage boosting device 50 may reach steady-state after a time period. Where operating conditions dictate that the regulated output-to-input current ratio is greater than 1, the value of the total output current and the output voltage may depend on the duty cycle of the first driving signal 116 and the duty cycle of the second driving signal 118. When the voltage boosting device is in steady-state, the voltage across the inductor 100, i.e., between nodes 112 and 110, when the second switch 104 is closed, may be equal to the voltage across the inductor 100, i.e., between nodes 112 and 114. In terms of an equation, V_{2ndon}=V₁ₛₜₒₙ. The voltage across the inductor 100, regardless of whether the first switch 102 is closed or the second switch 104 is closed, is equal to (Δl×L)/Δt. Because (Δl×L) is common to the both sides of the equation, it can be eliminated and the equation above, i.e., V_{2ndon}=V₁ₛₜₒₙ, is reduced to V_{2ndon}/Δt=V₁ₛₜₒₙ/Δt.

The Δt is directly related to the duty cycles of the second driving signal 118 and the first driving signal 116. For example, if the duty cycle of the second driving signal 118 is 0.5 and the duty cycle of the first driving signal 116 is 0.5, the second driving signal 118 may turn on the second switch 104 for 5 microseconds and off for 5 microseconds, and the first driving signal 116 may turn on the first switch 102 for 5 microseconds and off for 5 microseconds. In this embodiment, the Δt may be equal to 5 microseconds. Therefore, the equation above, i.e., V_{2ndon}/Δt=V₁ₛₜₒₙ/Δt, may be further reduced to V_{2ndon}/0.5=V₁ₛₜₒₙ/0.5=>V_{2ndon}=V₁ₛₜₒₙ.

In steady-state, where the duty cycle of the first driving signal 116 is 0.5 and the duty cycle of the second driving signal 118 is 0.5, V₁ₛₜₒₙ may be equal to a voltage across the output load, i.e., Vₒᵤₜ, minus the voltage input, i.e., Vᵢₙ, to the voltage boosting device. In steady-state, V_{2ndon} may be equal to the Vᵢₙ to the voltage boosting device 50. Thus, the equation above further reduces to Vₒᵤₜ−Vᵢₙ=Vᵢₙ. Solving this equation for Vₒᵤₜ, Vₒᵤₜ is equivalent to two times Vᵢₙ, i.e., Vₒᵤₜ=2×Vᵢₙ.

Thus, where operating conditions of the voltage regulator 10 dictate that the regulated output-to-input voltage ratio is greater than 1, the relationship between Vₒᵤₜ and Vᵢₙ may be directly related to the duty cycle of the first driving signal 116 and the second driving signal 118. For example, if the duty cycles of the first driving signal 116 is equal to 0.56 and the duty cycle of the second driving signal 118 is 0.44, the equation becomes Vₒᵤₜ−Vᵢₙ/0.56=Vᵢₙ/0.44. Solving this equation for Vₒᵤₜ, Vₒᵤₜ is approximately equal to 2.27 times Vᵢₙ.

In an embodiment of the invention, the oscillating device 30 may be located outside the voltage boosting device 50. In an alternative embodiment of the invention the oscillating device 30 may be located internal to the voltage boosting device 50. In the embodiment of the invention where the oscillating device 30 may be located outside the voltage boosting device 50, the oscillating device 30 may be configured utilizing discrete components, where the discrete component values may be varied to produce different duty cycles.

Where operating conditions of the voltage regulator 10 dictate that the regulated output-to-input voltage ratio is less than or equal to 1, i.e., the regulated DC output voltage utilized by the external load device 55 is lower than the input voltage, the value of the total output current and the regulated DC output voltage may depend more on the duty cycle of the first switching signal than on the duty cycle of the first driving signal 116 and the duty cycle of the second driving signal 118. As discussed previously, the average input voltage output from the switching device 15 may be directly related to the duty cycle of the first switching signal, which drives the pass switch 17.

Where operating conditions of the voltage regulator 10 dictate that the regulated output-to-input voltage ratio is less than or equal to 1, the duty cycle of the first driving signal may be much larger than the duty cycle of the second driving signal. In an embodiment of the invention, the first switch 102 may always be turned on, i.e., closed, meaning the first driving signal 116 may have a duty cycle of 1 and the second driving signal 116 may have a duty cycle of 0. In this embodiment, the regulated DC output voltage from the voltage boosting device 50 may be equal to the average voltage input received by the voltage boosting device 50. In other embodiments, the first driving signal may have a duty cycle of 0.9 and the second transistor driving cycle may have a duty cycle of 0.1. In this embodiment of the invention, the regulated output voltage from the voltage boosting device 50 may be approximately 1.1× the value of the average input voltage.

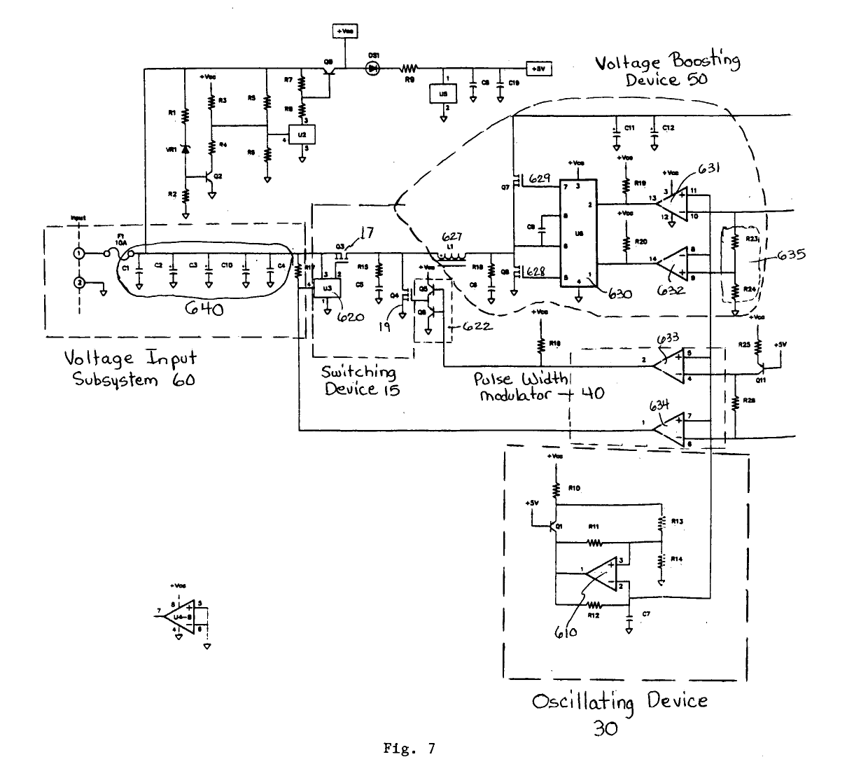

FIGS. 6 and 7 illustrate a specific embodiment of the present invention. The components of the voltage regulator 10 are outlined by dotted lines on the FIGS. 6 and 7. FIG. 6 illustrates the output correcting device 20 according to an embodiment of the present invention. An amplifier 712 provides a reference current input to a comparator 716. Amplifier 712 receives a supply voltage from a voltage generating device 710. The current control input, i.e., limit, is provided to the other terminal of comparator 716. The comparator 716 provides a correction signal. A resistor divider 722 provides the reference voltage input to a comparator 718. The voltage control input pin provides the voltage control input to the comparator 718. In this embodiment, the comparator 718 provides a correction signal.

A temperature protection circuit 724 is also shown. The temperature protection circuit 724 may disable the voltage regulator 10 if a temperature threshold is crossed.

FIG. 7 illustrates the oscillating device 30, the pulse width modulator 40, the voltage input subsystem 60, the switching device 15, and the voltage boosting device 50 according to a specific embodiment of the present invention.

The oscillating device 30 may include an amplifier 610 configured with a feedback path, to generate the oscillating signal, i.e., a triangular waveform, whose frequency is dependent upon resistive and capacitive components.

The pulse width modulator 40 may include a first comparator 633 and a second comparator labeled 634. The comparator 633 receives the correction signal from the output correction device 20 and receives the oscillating signal from the oscillating device 30. The comparator 633 outputs the second switching signal to the shunt switch 19 of the switching device 15. The comparator 634 receives a slightly modified correction signal and the oscillating signal and outputs a first switching signal to the pass switch 17 of the switching device 15.

The switching device 15 includes the pass switch 17 and the shunt switch 19 of the switching device 15. The pass switch 17 is controlled by the first switching signal. In this embodiment of the invention, the first switch is transmitted to a chip 620, which drives the pass switch 620. The shunt switch 19 is controlled by the second switching signal. The second switching signal is passed through a Darlington pair 622 to drive the second switching signal to drive the closing of the shunt switch 19 harder.

The voltage input subsystem 60 receives an external voltage input. A fuse prevents against surges in current. The capacitors 640 in the voltage input subsystem 60 are utilized to filter the external voltage input. The voltage input subsystem 60 is also utilized to generate a reference voltage, Vcc, which is utilized by other parts of the voltage regulator 10.

The voltage boosting device 50 includes a half-bridge driver 630, a comparator 631 and a comparator 632. The half-bridge driver 630 generates the first driving signal 116 and the second driving signal 118 to drive the first switch 629 and the second switch 628, respectively. The voltage boosting device 50 utilizes a resistor divider 635 to generate the first boost correction signal 170 and the second boost correction signal 172. The comparator 631 receives the oscillating signal and a first boost correction signal 174 and generates a high driving device signal 170 which is output to the half-bridge driver 630. The comparator 632 receives the second boost correction signal 176 and the oscillating signal, and generates a low driving device signal 172 which is output to the half-bridge driver 630.

While the description above refers to particular embodiments, it will be understood that many modifications may be made without departing from the spirit thereof. The accompanying claims are intended to cover such modifications as would fall within the true scope and spirit of the storm control method and apparatus. The presently disclosed embodiments are therefore to be considered in all respects as illustrative and not restrictive, of the scope of the storm control method and apparatus being indicated by the appended claims, rather than the foregoing description, and all changes that come within the meaning and range of equivalency of the claims are therefore intended to be embraced therein.

What is claimed is:

1. A voltage regulator, comprising:
a direct current (DC) input voltage;
a regulated DC output voltage;
a voltage boosting device, including a single inductor, to receive the DC input voltage and to output the regulated DC output voltage to an external load device while maintaining a necessary regulated output-to-input voltage ratio; and
an output correcting device to transmit a correction signal to direct the voltage boosting device to maintain the necessary regulated output-to-input voltage ratio.

2. The voltage regulator of claim 1, further including a voltage control input received from an external voltage control device wherein the correction signal of the output correcting device also directs the voltage boosting device to maintain an established ratio of the regulated DC output voltage divided by the voltage control input.

3. The voltage regulator of claim 2, wherein the correction signal is based on a reference output voltage derived from the regulated DC output voltage and the voltage control input.

4. The voltage regulator of claim 2, wherein the correction signal is based only on a reference output voltage derived from the regulated DC output voltage.

5. The voltage regulator of claim 2, wherein the correction signal is based on a reference output current derived from the regulated DC output voltage and a current control input.

6. The voltage regulator of claim 1, further including a switching device including a pass switch and a shunt switch to receive the DC input voltage and to output an input voltage to the voltage boosting device.

7. The voltage regulator of claim 6, wherein the pass switch is continuously closed or turned on when the ratio of the regulated DC output-to-input voltage is greater than 1, and the voltage boosting device boosts the regulated DC output voltage.

8. The voltage regulator of claim 7, wherein a magnitude of the regulated DC output voltage provided by the voltage boosting device is determined by a duty cycle of a first driving signal and a duty cycle of a second driving signal, wherein the first driving signal controls opening and closing of a first switch in the voltage boosting device and the second driving signal controls opening and closing of a second switch in the voltage boosting device.

9. The voltage regulator of claim 8, further including a driving device to generate the first driving signal and the second driving signal.

10. The voltage regulator of claim 9, wherein the driving device is a half-bridge driver.

11. The voltage regulator of claim 9, wherein the driving device receives a high driving device signal and a low driving device signal, the high driving device signal and the low driving device signal controlling the first driving signal and the second driving signal, respectively.

12. The voltage regulator of claim 11, wherein the voltage boosting device further includes a first comparator and a second comparator, wherein the first comparator receives a first boost correction signal, derived from the correction signal, and an oscillating signal, and outputs the high device driving signal, and the second comparator receives a second boost correction signal, derived from the correction signal, and outputs the low device driving signal.

13. The voltage regulator of claim 6, wherein the pass switch and the shunt switch are utilized by the switching device to create an average input voltage, and the voltage boosting device maintains or slightly increases the average input voltage to create the regulated DC output voltage.

14. The voltage regulator of claim 6, further including a pulse width modulator, the pulse width modulator coupled to the output correction device and coupled to the switching device, wherein the pulse width modulator outputs a first switching signal to the pass switch and outputs a second switching signal to the shunt switch based in part on the correction signal generated by the output correcting device.

15. The voltage regulator of claim 14, further including an oscillating device, the oscillating device coupled to the pulse width modulator, wherein the oscillating device outputs an oscillating signal to the pulse width modulator, and the first switching signal and the second switching signal are based in part on the oscillating signal.

16. The voltage regulator of claim 15, wherein the oscillating device is internal to the voltage boosting device.

17. The voltage regulator of claim 15, wherein the oscillating device is external to the voltage boosting device.

18. The voltage regulator of claim 1, further including a voltage generating subsystem coupled to the switching device, the voltage generating subsystem to receive an external input voltage and to output a DC voltage input.

19. The voltage regulator of claim 18, wherein the external input voltage is a rectified alternating current external input voltage.

20. The voltage regulator of claim 18, wherein the external input voltage is a DC external input voltage.

21. A voltage boosting device to increase an input voltage, comprising:
an inductor coupled to a switching device to receive the input voltage and to store a current; and
a first switch including a control terminal and a second terminal connected to the inductor;
a second switch including a second terminal coupled to a reference potential, a first terminal connected to the inductor, and a control terminal; and
a driving device coupled to the control terminal of the first switch and the control terminal of the second switch to drive the turning on and off of the first switch via a first driving signal and the second switch via a second driving signal to create a DC regulated output voltage that is larger than the input voltage, wherein the DC regulated output voltage is created when the current is output from the inducting device through the first switch when the first switch is closed and the second switch is open, and an increase of the input voltage as compared to the DC regulated output voltage is a function of a duty cycle of the first driving signal and a duty cycle of the second driving signal.

22. The voltage boosting device of claim 21, wherein the regulated DC output voltage is a factor of 1.1 to 2.25 greater than the input voltage.

23. The voltage boosting device of claim 21, further including a first comparator and a second comparator, wherein the first comparator generates a high driving device signal that is input to the driving device to create the first driving signal, and the second comparator generates a low driving device signal that is input to the driving device to create the second driving signal.

24. The voltage boosting device of claim 23, wherein the first comparator generates the high driving device signal by comparing an oscillating signal from an oscillating device and a first boost correction signal.

25. The voltage boosting device of claim 23, wherein the second comparator generates the low driving device signal by comparing an oscillating signal from an oscillating device to a second boost correction signal.

26. A voltage decreasing device to decrease an input voltage, comprising:
a switching device to receive an input voltage and to output an average input voltage;
an inductor coupled to the switching device to receive the average input voltage;
a first switch including a control terminal and a second terminal, the second terminal coupled to the inductor;
a second switch including a second terminal coupled to a reference potential, a first terminal connected to the inductor, and a control terminal; and
a driving device coupled to the control terminal of the first switch and the control terminal of the second switch to drive the turning on and off of a first switch via a first driving signal and the second switch via a second driving signal to create a regulated DC output voltage, wherein the regulated DC output voltage is created when the current is output from the inducting device to the output load when the first switch is closed and the second switch is open, the first driving signal has a high duty cycle to cause the closing of the first switch for a large period of time, and the DC regulated output voltage is smaller than the input voltage.

27. The voltage decreasing device of claim 26, wherein the switching device receives a first switching signal from a pulse width modulator to control the opening and closing of a path switch in the switching device and to create the average input voltage from the input voltage.

28. The voltage decreasing device of claim 27, wherein the switching device receives a second switching signal from the pulse width modulator to control the opening and closing of a shunt switch to create a path for current returning from the inductor when the pass switch is closed.

29. A method of regulating a DC output voltage, comprising:
receiving an input voltage at a voltage boosting device including a single inductor;
outputting, from the voltage boosting device, the regulated DC output voltage to an external load device while maintaining a regulated output-to-input voltage ratio; and
outputting a correction signal from an output correcting device to direct the voltage boosting device to maintain the regulated output-to-input voltage ratio.

30. The method of claim 29, further including receiving a voltage control input, and outputting the correction signal from the output correcting device to direct the voltage boosting device to an established actual-to-control voltage ratio.

31. The method of claim 29, further including receiving, at a switching device, a DC input voltage and outputting an input voltage equivalent to the DC input voltage.

32. The method of claim 31, wherein the input voltage from the switching device is increased by the voltage boosting device to create the regulated DC output voltage and the magnitude of the regulated DC output voltage is determined by a duty cycle of a first driving signal and a duty cycle of a second driving signal.
